(19) United States
(12) Patent Application Publication
(10) Pub. No.: US 2011/0017403 A1
(43) Pub. Date: Jan. 27, 2011

(54) Rigid Core for Making Tires

(75) Inventors: Miguel Torres-Castellano, Ceyrat (ES); Alain Soulalioux, Saint Beauzire (FR)

Correspondence Address: COHEN, PONTANI, LIEBERMAN & PAVANE LLP, 551 FIFTH AVENUE, SUITE 1210, NEW YORK, NY, 10176, US

(73) Assignees: Societe De Tecnologie Michelin, Clemont-Ferrand (FR); Michelin Recherche et Tecnique S.A., Granges Paccot (CH)

(21) Appl. No.: 12/682,202

(22) PCT Filed: Sep. 30, 2008
(86) PCT No.: PCT/EP2008/063083

§ 371 Date: Oct. 13, 2010

(30) Foreign Application Priority Data
Oct. 8, 2007 (FR) 0707062

(51) Int. Cl. B29D 30/32

(52) U.S. Cl. 156/421.6

(57) ABSTRACT

A rigid core which at least partly defines a manufacturing form for the inside surface of a tire, the core comprising a plurality of circumferentially adjacent segments (10) arranged side by side in contact with each other via their transverse faces, said transverses faces of at least one segment being convergent radially away from the core, each of said segments comprising an attachment part (13) for attachment to a locking member for locking the various segments (10), said attachment part (13) being provided at the radially inner edge of each of the segments (10), in which core at least one electrical heating resistor (17) is moulded into each of the segments (10); the electrical resistor comprises a heating resistor wire (17) running in a steel tube (16), and said segment (10) is essentially made from a grade of cast iron whose melting point is below the melting point of said steel tube (16).

The invention relates to the manufacture of tires. More specifically the present invention is concerned with the essentially rigid core used as a support in the manufacture of a tire and as a means for moulding the surface of the internal cavity of a tire.

Patent EP 1 075 928 and the divisional patent EP 1 371 479 which followed it, describe such a core, the job of which is to at least partly define a manufacturing form for the inside surface of the tire. This core is made up of multiple segments so that it can be removed from inside the tire through the space available between the beads. These segments are arranged side by side, in contact with each other at their transverse faces. Said transverse faces of at least one of the segments are convergent radially towards the interior of the core to allow demoulding.

In accordance with the publications cited above, said segments are made in two separate parts which each serve their own requirements: an attachment part and a main part connected to the attachment part. The function of the main part is to mould the inside surface of the tire, and that of the attachment part is to lock the various segments to a locking member which locks together the various segments making up one such core.

The attachment part is made of a first material selected for its ability to tolerate a large number of assembly and disassembly cycles. This attachment part is designed to optimise the grasping of each of the segments by the rim and by the various other manipulating members provided on the grippers installed at the manufacturing stations. The attachment part is typically made of machined steel, in order to create all the desired bearing surfaces and shapes.

Each of said segments also comprises a main part, connected to the attachment part, made of a second material that is not the same as the first material and is chosen for its castability and its good thermal conductivity. An electrical resistor is also moulded into each of these segments. This electrical resistor is located inside of the wall forming the radially outer dome, in order to encourage heat conduction. This segment also comprises a connector allowing electrical energy to be supplied to the resistors. The main part is typically made of aluminium alloy.

Publication U.S. Pat. No. 1,810,072 also discloses a rigid core comprising a main part in aluminium and an attachment part made in a different material.

Publication EP 893 237 also relies on the same principles and emphasises the expansion differential between the main part, in aluminium, and the attachment part, in steel, to increase the force with which the segments are clamped together.

All the publications cited above refer to the advantage of using aluminium to produce the main part, owing to its castability and its thermal conductivity properties, which are advantageously made use of when the core is used to hold the unfinished tire in position during the curing operation.

These publications also emphasise the magnitude of the clamping forces deployed during the use of the core, especially when the thermal expansions occur when said core is introduced into the curing press.

Proposals are therefore made to provide radial reinforcements to withstand these large forces. These reinforcements may take the form of transverse partitions, as proposed in publication EP 893 237, or pillars as indicated in publications U.S. Pat. No. 1,810,072 and EP 1 075 928, or circumferential partitions as suggested in publication EP 1 371 479.

However, the rapid development of passenger car tires in which the height-to-width ratio is becoming less and less necessitates the construction of a core in which the width of the main part is increased compared with its height. It follows that the pressure forces acting radially on the main part during closure of the core and during the moulding and curing operation are becoming greater and greater, with the consequence that there is a need for increasing reinforcement of the internal structures of the main part.

Furthermore, the reinforcing means are not easy to make because of the mechanical properties of aluminium alloys, which become less as the temperature increases. In certain geometrical configurations, a massive central part, meaning one in which the whole of the internal volume contains aluminium, proves to be still not enough to withstand the closure forces, leading to failure or deformation of the core, which by definition makes it unsuitable for the use for which it is intended.

It is an object of the invention to provide a contribution to dealing with this problem.

The rigid core according to the invention comprises a plurality of circumferentially adjacent segments arranged side by side in contact with each other via their transverse faces, said transverses faces of at least one segment being convergent radially away from the core. Each of said segments comprises an attachment part for attachment to a locking member for locking the various segments, said attachment part being provided at the radially inner edge of each of the segments. At least one electrical heating resistor runs through each of the segments. Said segment is essentially made of grey cast iron.

The use of cast iron to produce the segments of the core greatly increases the mechanical strength of said segments and thus solves the stated problem.

Moreover, cast iron is a material that has excellent casting qualities, allowing dimensionally highly accurate shapes to be produced.

In a first embodiment of the invention, the electrical heating resistor is arranged in a hollow channel formed in the mass of the cast iron of each of the segments.

In a second embodiment of the invention, the electrical heating resistor runs in a steel tube cast within the mass of each segment. The steel tube is selected such that the melting point of said steel is higher than the melting point of the cast iron.

The description which follows is based on an embodiment of the invention in which:

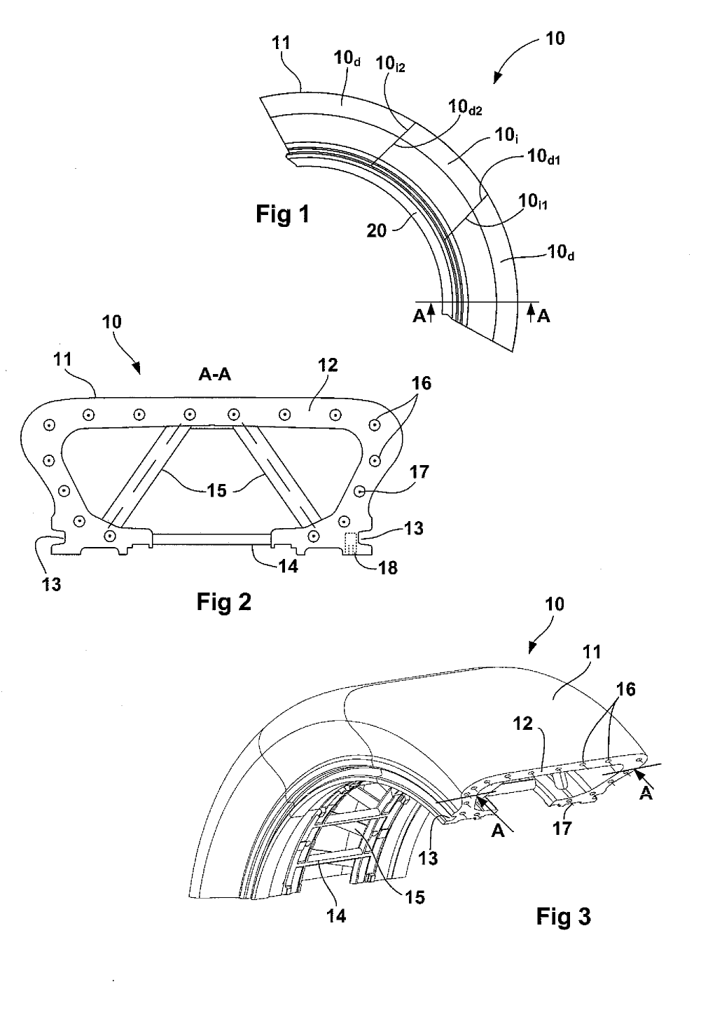

FIG. 1 is a partial side view of a rigid core,

FIG. 2 is a cross section on A-A through a segment of the core, and,

FIG. 3 is a partial perspective view of said core showing the cross section through a segment on A-A.

In the first embodiment of the invention, the hollow channel is made during the casting of said segment using ordinary casting techniques, such as sand casting techniques. The heating resistor is placed in the hollow channel after cooling and removal from the sand. The channel containing the heating resistor may also be filled with a material suitable for conducting heat, such as magnesium, so as to improve the thermal efficiency of the apparatus.

However, the production of segments in accordance with this first embodiment of the invention proves to be very expensive owing to the cost of the sand mould and the special care needed when making the channels, because particular attention must be paid to thermal homogeneity of the applied heat by directing the channels as close as possible to the radially outward surface of the segments of the core. This shape requires the channels to conform to the curvature of the surface and to be situated neither too close to the surface, to avoid hotspots, nor too far from the surface to avoid thermal losses.

In addition, this embodiment cannot be used to create channels with a diameter of less than about ten millimetres, which is a serious drawback when considering that it is desirable to increase the thermal reactivity of the core by improving the number of channels and reducing the thermal losses in the channel.

An alternative has thus been developed which constitutes the preferred embodiment of the invention, and in which the heating resistor is placed in a tube, generally of steel, beforehand. The description which follows will therefore relate more particularly to this second embodiment of the invention.

FIG. 1 shows the main outlines of a rigid core made up of segments 10 as described by way of example in publication EP 1 075 928. This rigid core at least partly defines a manufacturing form whose surface 11 corresponds to the inside surface of a tire.

The core comprises a plurality of circumferentially adjacent segments 10_{d}, 10ᵢ, arranged side by side in contact with each other at their transverse faces 10_{d1} and 10ᵢ₁ or 10_{d2} and 10ᵢ₂. The transverse faces 10ᵢ₁ and 10ᵢ₂ of at least one segment 10ᵢ are convergent away from the core, to allow said core to be disassembled by removing this segment 10ᵢ via the interior. In practice, the core comprises two sorts of segment: divergent segments 10_{d} whose transverse faces 10_{d1} and 10_{d2} are divergent radially away from the core, and so-called reverse segments 10ᵢ whose transverse faces 10ᵢ₁ and 10ᵢ₂ are convergent away from the core.

Each of the segments 10 comprises an attachment part 13 for attachment to a rim 20, said attachment part being located at the radially inward edge of each of the segments. The rim 20 is circumferentially continuous. Patent EP 1 075 928 describes an example of an embodiment of the attachment of the segments to the rim and the reader may usefully refer to that publication for details on this specific function.

During the casting of said segment, in the foundry, steel tubes 16 are moulded into the mass 12 of the segment as shown in FIG. 2. A heating wire 17 runs through these tubes and is supplied with electricity via a connector 18 connected to the rim 20. As a general rule, the heating wire is embedded in a mixture of magnesium so that the wire is held in position within the tube. Provision is made, as already mentioned, to locate the heating elements at a precise distance from the wall 11 forming the radially outer dome of said segment of the core, to ensure good heat diffusion while avoiding the formation of cold areas and hot sports.

Each core segment thus comprises its own heating system, which heating system takes the form for example of a coil running under the surface 11 of the core segment 10.

The core segment is made of cast iron. This material has excellent mechanical strength at high temperature, enabling it to withstand the clamping forces imposed on the core segments 10 when the core is being put together and introduced into a curing apparatus. Cast iron also has highly desirable casting properties, allowing the creation of segments by conventional casting methods, using a sand mould, for example.

The thermal conduction properties of cast iron are inferior to those of aluminium, but its ability to store thermal energy is much greater. As a result, the total electrical energy consumption is less than would have had to be supplied to an aluminium mould of comparable dimensions.

The properties of cast iron are defined by its carbon content, which is between 1.7% and 6.67% relative to the mass of iron. The melting point of cast iron is between 1135° C. and 1350° C., depending on the percentage by mass of carbon and silicone which it contains. As an example, good results have been obtained with a cast iron containing 5% carbon, with a melting point of as much as 1250° C.

Reinforcements 14 and 15 can be added to increase the mechanical strength of the core segment 10.

The tube 16 containing the heating wire 17 is made of steel, usually stainless steel. The melting point of steel is between 1150° C. and 1480° C., mainly depending on the percentage of carbon which it contains. Therefore, a steel with a low level of carbon will be selected in order to raise the melting point and give a certain malleability to the steel tube to make it easier to shape the heating resistor. The diameter of the tube is from 5 to 10 mm, and arrangements will be made to reduce this diameter as far as possible in order to improve the thermal reactivity of the heating means. In practice, good results have been obtained with a 6.5 mm diameter tube.

The difference between the melting points of cast iron and steel makes it possible to embed the heating resistor in the mass 12 of the core segment 10 during the casting of the cast iron mass, without the shape and properties of the electrical resistor being damaged by this manufacturing operation. It will be observed, too, that the greater the difference between the melting point of the cast iron and the melting point of the steel forming the tube, the easier the casting and moulding will be, because of the greater geometrical stability of the tube during the casting of the cast iron.

In practice, a steel containing 0.5% carbon and with a melting point of as much as 1450° C. has satisfactory properties for the intended application.

It would however be possible to make the core segments from a steel of a grade selected so that its melting point is lower than the melting point of the material forming the tube containing the heating resistor. Nonetheless, it is known that steel is difficult to cast and its castability properties are inferior to those of cast iron, which is a deterrent to making parts with complex shapes.

The principles of the invention could therefore be applied in an equivalent manner by selecting a pair of metals having different melting points and in which at least one of the metals has sufficiently good mechanical properties to cope with the mechanical stresses of the core. In this respect, the combination of cast iron and steel has the desired characteristics and allows implementation at advantageous costs.

it will be observed, lastly, that the gaps between the faces of the core segments can be zero. This is because the thermal expansions that occur between assembly of the segments and curing occur evenly because of the majority presence of cast iron in the core (the effect of the presence of the steel tubes is assumed to be negligible). There is therefore much less trouble with rubber escaping between the segments at the transverse faces.

1. A rigid core which at least partly defines a manufacturing form for the inside surface of a tire and which is designed to support the unfinished tire during the moulding and curing operation, the core comprising a plurality of circumferentially adjacent segments arranged side by side in contact with each other via their transverse faces, said transverses faces of at least one segment being convergent radially away from the core, each of said segments comprising an attachment part for attachment to a locking member for locking the various segments, said attachment part being provided at the radially inner edge of each of the segments, in which core at least one electrical heating resistor is placed in a channel running inside the wall forming the radially outer dome of each of the segments,
wherein each of said segments is essentially made of cast iron.

2. The rigid core according to claim 1, wherein the channel in which the heating resistor runs conforms to the curvature of the radially outer surface of the core segment in which it is located.

3. The rigid core according to claim 2, wherein the diameter of the channels is less than 10 mm.

4. The rigid core according to claim 1, wherein the electrical resistor is embedded in a material that is a good heat conductor.

5. The rigid core according to claim 4, wherein the electrical resistor is embedded in magnesium.

6. The rigid core according to claim 1, wherein the electrical resistor is placed in a tube made of a material having a melting point that is higher than the melting point of the cast iron, and wherein said tube is embedded in the cast iron during the moulding operation of said portion.

7. The rigid core according to claim 6, wherein the tube is made of steel.

8. The rigid core according to claim 1, wherein a connector is implanted, enabling said core to be connected to an electrical power source to supply electrical energy to the electrical resistors.
